(19) United States
(12) Patent Application Publication
(10) Pub. No.: US 2008/0018953 A1
(43) Pub. Date: Jan. 24, 2008

(54) Image data recording apparatus, computer readable medium, and data structure

(75) Inventors: Eiichi Narimatsu, Tokyo (JP); Tadashi Suzue, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/822,663

(22) Filed: Jul. 9, 2007

(30) Foreign Application Priority Data
Jul. 19, 2006 (JP) 2006-196944

(51) Int. Cl. H04N 1/40

(52) U.S. Cl. 358/471

(57) ABSTRACT

Disclosed an image data recording apparatus including: a memory storage control section to sequentially store inputted image data into a space area of the internal memory, and every time the storing is completed, to sequentially register, in a write list, memory area information about an area to which the image data has been stored, the memory area information including a start address of the area; and a write control section to specify the area in which the inputted image data is stored based on the memory area information, to allow the write section to write the data of the area into the optical recording medium from a head of the optical recording medium, and to write, into the optical recording medium, medium area information which is the memory area information in which the start address on the internal memory is changed to a start address on the optical recording medium.

### CROSS-REFERENCE TO RELATED APPLICATION

The present U.S. patent application claims a priority under the Paris Convention of Japanese patent application No. 2006-196944 filed on Jul. 19, 2006, which shall be a basis of correction of an incorrect translation.

### BACKGROUND

1. Field of the Invention

The present invention relates to an image data recording apparatus including a function to write sequentially inputted image data sequentially into an optical recording medium, and to a medium and a data structure.

2. Description of Related Art

Heretofore, in an image forming apparatus such as a copier and a printer, image data read by a scanner and image data inputted from an external equipment have been recorded in an optical recording medium such as a compact disc (CD) and a digital versatile disc (DVD) (for example, see Japanese Patent Application Laid-open Publication No. 2002-41337).

In the optical recording medium, unlike a hard disk drive (HDD), such data cannot be written while repeating rewriting. Therefore, in the case of writing the data into the optical recording medium, an image file has been generated based on the data to be written thereinto by using the HDD or the like, and the generated image file is written into the optical recording medium.

However, in above-described technique to generate the image data and to write the image data into the optical recording medium, a capacity equivalent to a size of the data to be written into the optical recording medium is required in order to generate the image data in the HDD or the like. Moreover, since the image file of the data to be written is completed and then the completed image file is written into the optical recording medium, such writing target data cannot be added while the data is being written into the optical recording medium. Therefore, in the image data recording apparatus which writes image data sequentially transferred from a scanner or an external equipment to an internal memory into an optical recording medium, it was necessary to generate the image file after waiting for the entirety of the writing target image data to be captured into the internal memory, and then start writing the generated image file into the optical recording medium. Hence, there have been problems that it takes long to perform this processing and that a large storage capacity becomes necessary.

### SUMMARY

It is an object of the present invention to make it possible, in the image data recording apparatus, to write the image data sequentially inputted thereto sequentially into the optical recording medium.

To realize at least one of the abovementioned objects, an image data recording apparatus according to one embodiment that reflects one of aspects of the present invention includes: an input section on which image data is inputted; an internal memory; a write section to write data into an optical recording medium which is removably mounted onto the write section; a memory storage control section to sequentially store the image data inputted from the input section into a space area of the internal memory, and every time the storing of the image data is completed, to sequentially register, in a write list, memory area information about an area to which the image data has been stored, the memory area information including a start address of the area; and a write control section to specify the area in which the inputted image data is stored based on the registered memory area information, to allow the write section to write the data of the specified area into the optical recording medium from a head of the optical recording medium, and to write, into the optical recording medium, medium area information which is the memory area information in which the start address of the data on the internal memory is changed to a start address of the data on the optical recording medium.

Preferably, in the image data recording apparatus, after the write section writes an entirety of the image data which is inputted by the input section and is specified to be written and corresponding medium area information into the optical recording medium, the write control section writes, into the optical recording medium, apparatus identification information about an apparatus permitted to read the image data written in the optical recording medium.

Preferably, in the image data recording apparatus, the memory area information includes image identification information about the image data stored in the area, and when the image data composing one image is stored over a plurality of the areas, the memory storage control section registers identical image identification information to a plurality of pieces of the memory area information about the respective areas in which the image data composing the one image is distributed and stored.

Preferably, in the image data recording apparatus, the input section is a scanner to read an image of a document so that image data is inputted thereon.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein:

FIG. 1 is a view showing an entire configuration of an image forming system according to the embodiment of the present invention.

FIG. 2 is a block diagram showing a functional configuration of an image forming apparatus according to the embodiment of the present invention.

FIG. 3 is a flowchart showing disc detecting processing executed by a CPU of the image forming apparatus according to the embodiment.

FIG. 4A is a flowchart showing write control processing executed by the CPU of the image forming apparatus according to the embodiment.

FIG. 4B is a flowchart showing write control processing executed by the CPU of the image forming apparatus according to the embodiment.

FIG. 5 is a flowchart showing write list registration processing executed by the CPU of the image forming apparatus according to the embodiment.

FIG. 6 is a view showing a data storage example of a write list according to the embodiment.

FIG. 7A is a view showing an example of a data structure of an image format file written into a disc in the write control processing of FIG. 4.

FIG. 7B is a view showing formats of the respective pieces of data information stored in the data structure of FIG. 7A.

FIG. 7C is a view showing a format of each permitted apparatus list stored in the data structure of FIG. 7A.

FIG. 8 is a flowchart showing data analysis processing executed by the CPU of the image forming apparatus according to the embodiment.

FIG. 9 is a flowchart showing image read processing executed by the CPU of the image forming apparatus according to the embodiment.

### DETAILED DESCRIPTION OF THE PREFERRED EMBODIMENT

Hereinafter, an embodiment of the present invention will be described in detail with reference to the drawings. The scope of the invention is not limited to examples shown in the drawings.

One embodiment of an image data recording apparatus of the invention is an image forming system which embodies the image data recording apparatus of the invention.

First, an example of the image forming system will be explained, and then an example of the image data recording apparatus will be explained.

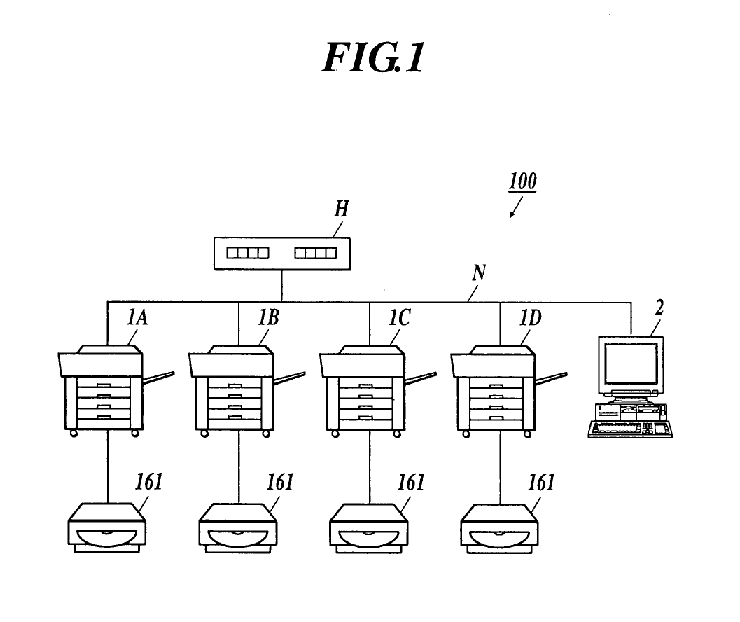

FIG. 1 is a conceptual view showing an entire configuration of an image forming system 100. As shown in FIG. 1, the image forming system 100 is a system composed in such a manner that a plurality of image forming apparatuses 1 and a host computer 2 are connected to a communication network N such as a local area network (LAN) through a hub H. Note that, here, an example is shown, where four image forming apparatuses 1 (1A to 1D) are connected to the communication network N; however, the number of image forming apparatuses 1 is not particularly limited.

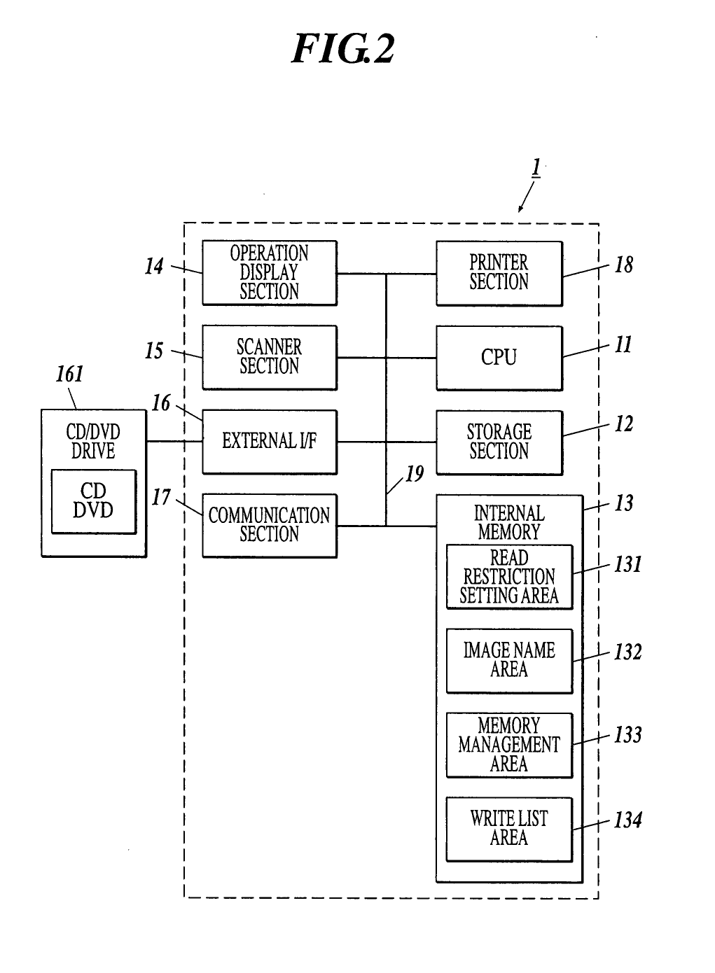

FIG. 2 is a block diagram showing a functional configuration of the image forming apparatus 1.

As shown in FIG. 2, the image forming apparatus 1 includes a central processing unit (CPU) 11, a storage section 12, an internal memory 13, an operation display section 14, a scanner section 15, an external I/F 16 to which a CD/DVD drive 161 is connected, a communication section 17, a printer section 18, and the like. The respective sections are interconnected by a bus 19.

The CPU 11 reads out a system program, a variety of processing programs, and a variety of application programs, which are stored in the storage section 12, expands these programs to the internal memory 13, and controls operations of the respective sections of the image forming apparatus 1 in a centralizing manner in accordance with the expanded programs.

The storage section 12 is composed of a semiconductor nonvolatile memory and the like, and prestores the system program ready for the image forming apparatus 1, the variety of processing programs including a write control processing program, the variety of application programs including write software, a variety of pieces of data for use in these programs, and the like. Moreover, the storage section 12 stores MAC addresses as apparatus identification information about the respective apparatuses connected to the communication network N.

The internal memory 13 becomes a temporal storage area for the programs read out from the storage section 12, input or output data, parameters, and the like, in a variety of processing executed and controlled by the CPU 11.

In this embodiment, the internal memory 13 forms a read restriction setting area 131 for storing information indicating whether or not to put a restriction on reading image data to be written into a CD or a DVD, the information being inputted from a read restriction setting screen (not shown) of the operation display section 14, and for storing the MAC addresses of permitted apparatuses which are permitted to read the image data in the case of putting the restriction on reading. Moreover, the internal memory 13 forms an image name area 132 for storing a name of the image data, which is inputted from an image name setting screen (not shown) of the operation display section 14. Furthermore, the internal memory 13 forms a memory management area 133 for storing information for managing the areas of the internal memory 13 (information indicating a start address, an end address and an area size for each continuous area formed on the internal memory 13 and indicating whether or not the area concerned is currently used). Still further, the internal memory 13 forms a write list area 134 for storing a write list 134a to be described later.

The operation display section 14 is composed of a liquid crystal display (LCD) or the like. The operation display section 14 displays, on a screen, a variety of setting screens, a state of an image, operation situations of the respective functions, and the like in accordance with instructions of display signals from the CPU 11. On the screen of the LCD, a touch panel of a pressure sensitive type (resistive film type), in which transparent electrodes are arranged in a matrix, is composed, and the touch panel detects a current value of an XY coordinate of a point depressed by a finger, a touch pen, or the like, and as an operation signal, outputs a detected position signal to the CPU 11.

The scanner section 15 is composed of an auto document feeder (ADF), and a scanner.

The ADF includes a document tray for mounting original documents thereon, and conveys the documents mounted on the document tray to a document read position on contact glass of the scanner one by one. Then, when the documents are finished being read by the scanner, the ADF conveys and discharges the documents to a document ejection tray.

The scanner projects light onto the documents mounted on the document read position on the contact glass, forms images from reflected light of the projected light by a charge coupled device (CCD), and subjects the images to photoelectric conversion. In such a way, the scanner reads the images of the documents, converts the read images into digital image data by an A/D converter, and outputs the digital image data to the internal memory 13.

The external I/F 16 is an interface for connecting the CD/DVD drive 161 to the image forming apparatus 1, and performing data input/output therebetween.

The CD/DVD drive 161 is composed so as to be capable of mounting an optical recording medium such as a CD and a DVD thereonto and unmounting the optical recording medium therefrom. The CD/DVD drive 161 writes the data onto the mounted optical recording medium, and reads the data from the optical recording medium. Specifically, the CD/DVD drive 161 has a function as a write section. Note that, though the optical recording medium is described as the CD or the DVD in this embodiment, the optical recording medium is not limited to this.

The communication section 17 is composed by including a communication interface such as a network interface card (NIC) and a modulator-demodulator (MODEM), and mutually performs data transmission/reception with an external equipment connected to the communication network N.

The printer section 18 is a printer engine including a conveyor device of recording sheets, a photosensitive drum, an electricity charging device, a laser unit, a development device, a transfer/separation device, a cleaning device, and a fixing device. The printer section 18 forms images corresponding to the image data on the recording sheets by an electrophotographic process, and outputs the images.

The host computer 2 transmits the printing target image data to the image forming apparatus 1.

In a construction of the above-described image forming system 100, the image data recording apparatus includes the CPU 11, the storage section 12, the internal memory 13, scanner section 15, external I/F 16, and the CD/DVD drive 161 which are included in the above described image forming apparatus 1.

Next, an operation of the image data recording apparatus according to the embodiment will be described. Note that the operation display section 14 is subsidiarily used in a following operation.

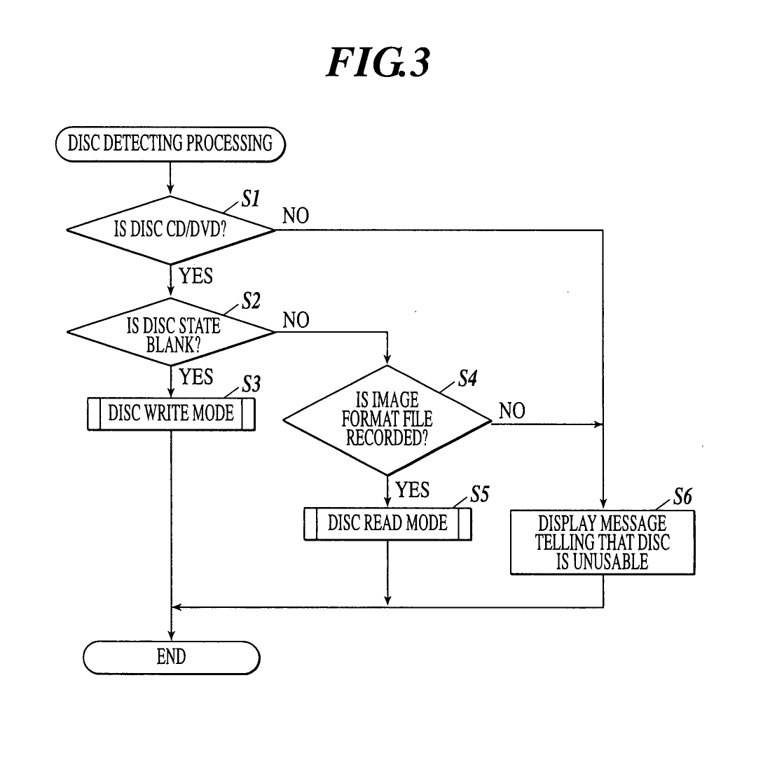

FIG. 3 is a flowchart showing disc detecting processing executed by the CPU 11. This processing is processing realized by software processing executed by cooperation between the CPU 11 and a disc detecting processing program stored in the storage section 12 when the disc is mounted onto the CD/DVD drive 161.

When the disc is mounted onto the CD/DVD drive 161, a file system of the mounted disc is referred to, and it is judged whether the mounted disc is the CD or the DVD. When it is judged that the mounted disc is the CD or the DVD (Step S1: YES), it is judged whether or not a state of the mounted disc is blank. When it is judged that the state is blank (Step S2: YES), the processing proceeds to a disc write mode as an operation mode of writing the data into the disc, where processing in the disc write mode is executed (Step S3).

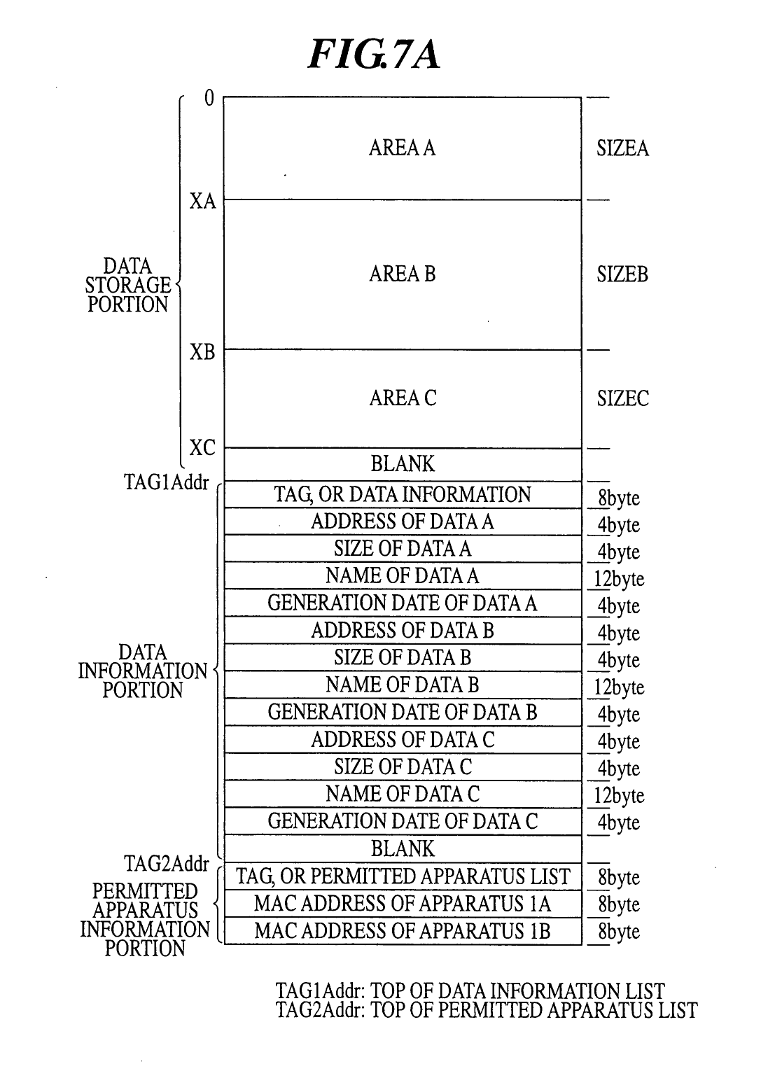

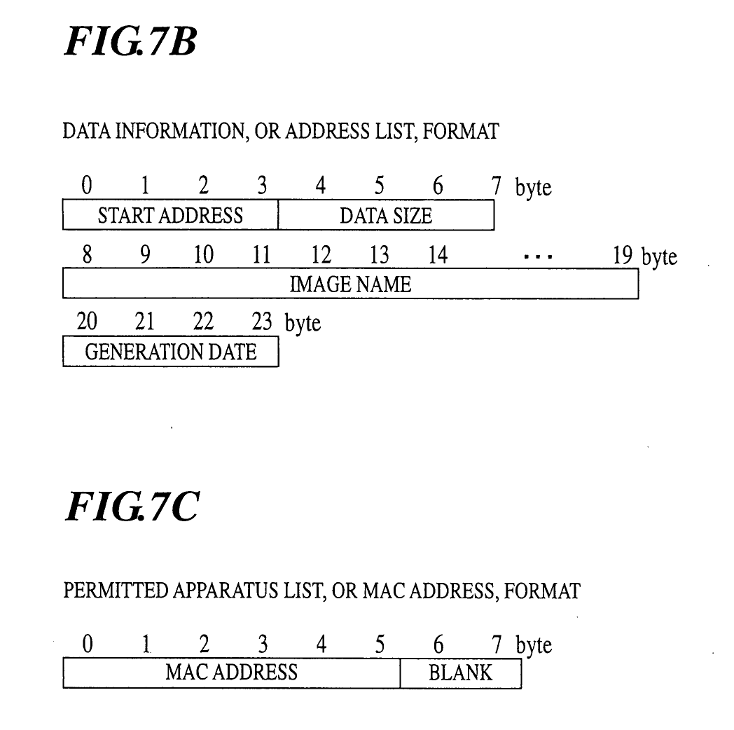

When it is judged that the state of the mounted disc is not blank (Step S2: NO), it is judged whether or not a file recorded in the mounted disc is an image format file. When it is judged that the file is the image format file (Step S4: YES), the processing proceeds to a disc read mode as an operation mode of reading the data from the disc, where processing in the disc read mode is executed (Step S5). Here, the image format file refers to a file with a data structure shown in FIG. 7A, which is written in write control processing to be described later.

Meanwhile, when it is judged in Step S1 that the mounted disc is not the CD or the DVD (Step S1: NO), or when it is judged in Step S4 that the file recorded in the mounted disc is not the image format file (Step S4: NO), an error message to the effect that the disc is unusable is displayed on the operation display section 14 (Step S6), and this processing is ended.

Next, an operation in the disc write mode will be described.

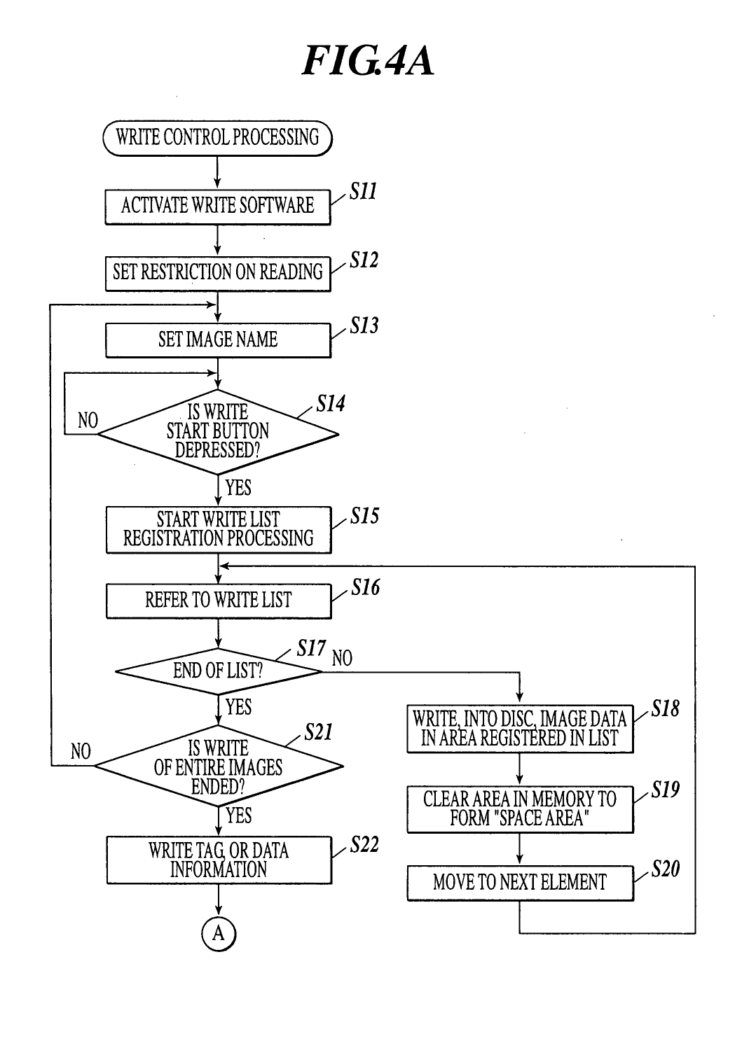

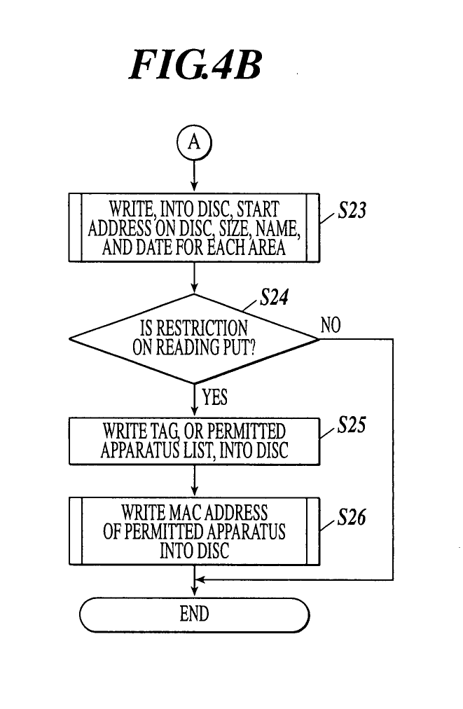

FIG. 4 is a flowchart showing the write control processing executed by the CPU 11. This processing is processing realized by software processing executed by cooperation between the CPU 11 and the write control processing program stored in the storage section 12. A write control section is realized by executing this processing.

First, the write software is read out from the storage section 12 into the internal memory 13, and is activated (Step S11). Subsequently, on the operation display section 14, the read restriction setting screen for putting a restriction on reading for the image data to be written into the disc is displayed, and the restriction on reading is set in response to the input from the operation display section 14 (Step S12). On the read restriction setting screen, though not shown, there are displayed a selection button as to whether or not to put the restriction on reading the image data to be written into the disc, and a permitted apparatus selection column for selecting the apparatuses (permitted apparatuses) which are permitted to read the image data in the case of putting the restriction on reading. In the permitted apparatus selection column, a list of the respective apparatuses (image forming apparatus 1, host computer 2, and the like) connected to the communication network N is displayed. In a state where a selection button to instruct the putting of the restriction on reading is selected, it becomes possible to select, from the list, the apparatus that is permitted to read the image data. When the selections as to whether or not to put the restriction on reading and of the permitted apparatuses in the case of putting the restriction on reading are inputted by depression operations on the read restriction setting screen, inputted contents (information as to whether or not to put the restriction on reading, and the MAC addresses of the permitted apparatuses in the case of putting the restriction on reading) are set in the read restriction setting area 131 of the internal memory 13.

Subsequently, the image name setting screen (not shown) for setting an image name of the image data to be written into the disc as image identification information is displayed on the operation display section 14, and contents inputted on this screen are set in the image name area 132 of the internal memory 13 (Step S13).

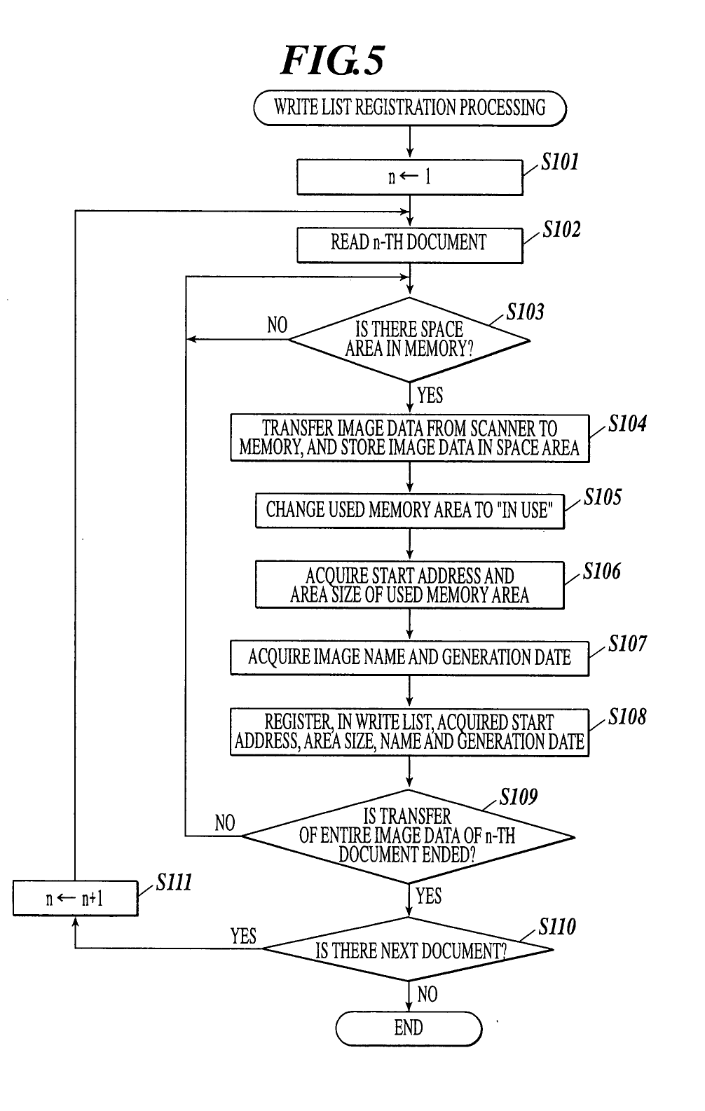

Subsequently, depression of a write start button (start button) from the operation display section 14 is awaited. When a batch of documents to be written into the mounted disc are set on the document tray, and the write start button is depressed (Step S14: YES), a write list registration processing shown in FIG. 5 is started (Step S15).

FIG. 5 is a flowchart showing the write list registration processing executed in Step S15 of FIG. 4. This processing is processing realized by software processing executed by cooperation between the CPU 11 and a write list registration program stored in the storage section 12. A memory storage control section is realized by executing this processing.

First, one (1) is set in a counter n (Step S101), and an n-th document is read by the scanner section 15 (Step S102). Subsequently, the memory management area 133 is referred to, and it is judged whether or not there is a space area in the internal memory 13 (Step S103). When it is judged that there is no space area in the internal memory 13 (Step S103: NO), it is awaited that the memory is cleared by another processing to form the space area in the internal memory 13. When it is judged that there is a space area in the internal memory 13 (Step S103: YES), the processing proceeds to Step S104. Here, the judgment as to whether or not there is a space area in the memory is executed based on whether or not there are one or more continuous space areas in the internal memory 13, and an area size of the space area does not matter.

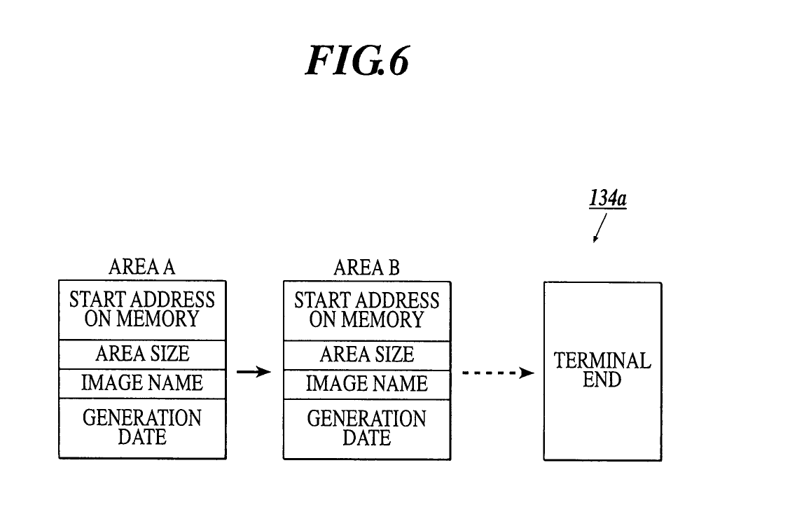

In Step S104, one of the continuous space areas of the internal memory 13 is decided as a transfer destination, and image data of the n-th document read in the scanner section 15 is transferred to the space area of the transfer destination, and is stored there (Step S104). Here, when the area size of the space area as the transfer destination is smaller than a size of the image data of the n-th document, image data of an amount of the area size of the transfer destination is transferred from the scanner section 15, and is stored in the space area. When the image data is stored in the internal memory 13, state information in the memory management area 133, which is for the memory area used for storing the image data, is changed to “in use” and registered (Step S105). Then, the start address and area size of the used memory area are acquired from the memory management area 133 (Step S106), the image name is acquired from the image name area 132, and further, a date of generating the image data is acquired from a system clock (Step S107), and the start address, the area size, the image name, and such a generation date, which are thus acquired, are registered as memory area information into the write list 134a (see FIG. 6) (Step S108).

After the registration into the write list 134a, it is judged whether or not the transfer of the entire image data of the n-th document from the scanner section 15 is completed. When it is judged that the registration is not ended (Step S109: NO), the processing returns to Step S103, from which the processing of Steps S103 to S108 is repeatedly executed. Specifically, when the size of the continuous space area of the internal memory 13 is larger than the size of the image data read by the scanner section 15, the entire image data of the n-th document is transferred to one space area, and is stored there. Then, the start address, the area size, the image name and the generation date for the area concerned are registered in the write list 134a. When the area size of the continuous space area in the internal memory 13 is less than the area size for the image data to be transferred, the processing for transferring the data to one of the space areas and registering a result of the transfer into the write list is repeatedly executed until the storage of the entire image data is completed. Note that, with regard to the image name, the image name set by a user in Step S13 of FIG. 4 and an image read number n are written. Specifically, even if the image data obtained by reading one document is stored separately in the plurality of areas in the internal memory 13, an identical image name is registered for the separately stored image data. Consequently, by the image name registered in the write list 134a, it becomes possible to identify the areas in the memory, in which a plurality of the pieces of the data composing the image data of one document are stored respectively.

When it is judged that the transfer of the entire image data of the n-th document from the scanner section 15 is completed (Step S109: YES), it is judged whether or not there is a document to be read next. When it is judged that there is such a document to be read next (Step S110: YES), the counter n is incremented by one (1) (Step S111), and the processing returns to Step S102. When it is judged that there is no document to be read next (Step S110: NO), this processing is ended.

FIG. 6 is a view showing a data storage example of the write list 134a. As shown in FIG. 6, in the write list 134a, the memory area information formed of the start address, the area size, the image name, and the generation date is registered for each of the memory areas into which the image data is written. The individual piece of the memory area information, which is registered in the write list 134a, refers to a list element. When the image data is stored in a new area in the internal memory 13, the list element for the area in which the image data is newly stored is additionally registered in an end of the list.

Returning to FIG. 4, when the write list registration processing is started, and the write list 134a is registered in the write list area 134, the write list 134a is referred to (Step S16). When the write list 134a is referred to for the first time in this processing, a pointer is set to the top list element, and contents of the top list element are referred to. In Step S20 to be described later, the pointer is sequentially moved to the next list elements. When the reference to the contents of the list elements is entirely finished, the pointer is set to the end of the list.

When the pointer does not reach the end of the list, and it is possible to refer to the contents of the list elements (Step S17: NO), the area in the internal memory 13, in which the image data to be written is stored, is specified based on the start addresses and the area sizes, which are included in the list elements referred to in the write list 134a, and the image data in the specified area is written into the mounted disc by the CD/DVD drive 161 driven by the write software (Step S18). After this writing, the area in-the internal memory 13 is cleared, and the state information in the memory management area 133, which relates to the area concerned, is changed to “space area” (Step S19). Then, the pointer is moved to the next list element (Step S20), and the processing returns to Step S16. Note that, in the write software, when the data in the area in the internal memory 13 is written into the disc, the start address of the area into which the image data is written is held in the disc. Specifically, also in the disc, the image data is managed per area section in which the image data is stored in the internal memory 13.

Meanwhile, in Step S17, when the pointer reaches the end of the write list 134a, and there is no list element to be referred to next (Step S17: YES), a dialogue to inquire whether such writing to the disc is to be ended or to be continued is displayed on the operation display section 14. When an operation for instructing to continue the writing is inputted from the dialogue (Step S21: NO), the processing returns to Step S13, from which the processing of Steps S13 to S20 is executed for a batch of the documents, which is newly mounted on the document tray. When an operation indicating the end of the writing is inputted from the dialogue (Step S21: YES), the processing proceeds to Step S22.

In Step S22, TAG (data information) is written into the disc by the write software (Step S22). The TAG (data information) is separation information indicating that attribute information regarding the written data is written subsequently to this TAG.

After the writing of the TAG (data information), there are acquired the contents of the respective list elements (memory area information) of the write list 134a, and the start addresses, which is held by the soft ware, of the respective areas on the disc where the image data is written. Then, subsequently to the TAG (data information), the data information about each of the areas on the disc, which is formed of the start address on the disc, a data size, the image name, and the generation date is written into the disc by the write software (Step S23). Subsequently, the read restriction setting area 131 is referred to. When the restriction on reading is not set (Step S24: NO), this processing is ended. When the restriction on reading is set (Step S24: YES), TAG (permitted apparatus list) is written into the disc (Step S25). The TAG (permitted apparatus list) is information indicating that the MAC addresses of the permitted apparatuses which are permitted to read the image data is written subsequently to the TAG.

After the writing of the TAG (permitted apparatus list), the MAC addresses of the permitted apparatuses thus set are sequentially written into the disc (Step S26), and this processing is ended. After the write control processing is ended, the contents of the read restriction setting area 131, the image name area 132, the memory management area 133, and the write list area 134 are cleared. Moreover, the write software is also ended.

The data written into the disc as the CD or the DVD by the above-described processing is managed as one file (the image format file) on the disc. This is realized in such a manner that, at the end of an execution of the write software, a file name (for example, image name, generation date, and the like which are set first) and a predetermined identifier indicating that the data is an image format file are imparted to a series of the data written into the disc this time by the write software, and that such a pair of the file name and the identifier is written into the file system of the disc.

FIG. 7A is a view showing an example of the data structure of the image format file written into the disc in the write control processing. As shown in FIG. 7A, the image format file includes a data storage section, a data information section, and a permitted apparatus information section in order from the start address side in the file. Note that, when there is no restriction on permitting reading, the permitted apparatus information section is not present. The data storage section stores the image data read out from the internal memory 13 and sequentially written thereinto. The data information section stores the TAG (data information), and the data information about each area on the disc into which the image data is written. The permitted apparatus information section stores the TAG (permitted apparatus list) and the MAC addresses of the permitted apparatuses. When the restriction on reading is not put, the TAG (permitted apparatus list) and the MAC addresses of the permitted apparatuses are not present. As described with reference to FIG. 4, the respective pieces of the image data, which are read from the scanner section 15, are stored in the one or more space areas of the internal memory 13. Moreover, the start address, the area size, the image name, and the generation date are registered in the write list 134a for each of the areas. Furthermore, the image data is written into the disc per area section written into the write list 134a. Consequently, also in the disc, the image data is written and managed per area section written into the internal memory 13. Hence, in the data information section, the data information per written section into the disc is stored in a written order. As shown in FIG. 7B, each piece of the data information is composed of 24 bytes of data when the image data is stored on the disc, which are: the start address (4 bytes); the data size (4 bytes); the image name (12 bytes), and the generation date (4 bytes). As shown in FIG. 7C, for each MAC address, 8 bytes are allocated, of which 2 bytes are blank.

The above description is the operations in the disc write mode.

Next, operations in the disc read mode will be described.

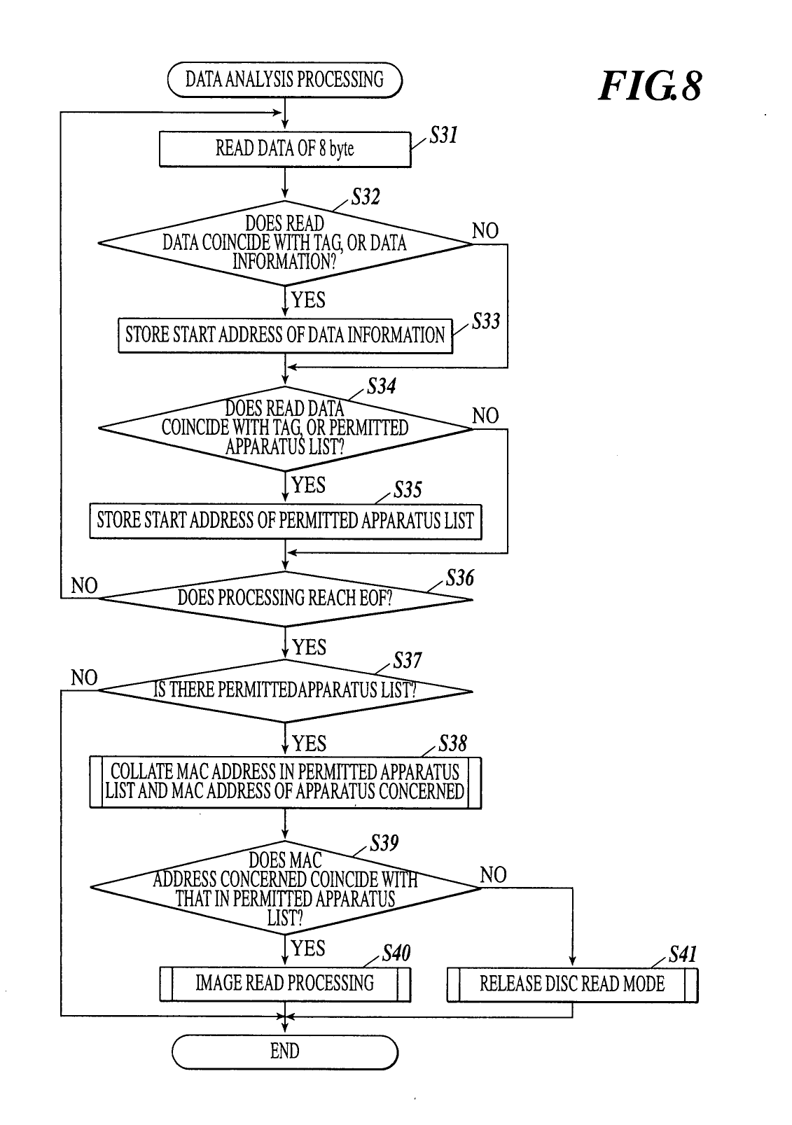

FIG. 8 is a flowchart showing data analysis processing executed by the CPU 11. This processing is processing realized by software processing executed by cooperation between the CPU 11 and a data analysis processing program stored in the storage section 12 when the mode of processing is shifted to the disc read mode.

First, data with a fixed size (size of the TAG (data information); here, 8 bytes) is read out from the image format file on the disc into the internal memory 13 (Step S31), and it is judged whether or not the read data coincides with the TAG (data information) (Step S32). When it is judged that the read data does not coincide with the TAG (data information) (Step S32: NO), the processing proceeds to Step S34. When it is judged that the read data coincides with the TAG (data information) (Step S32: YES), the start address on the disc in which the read data is stored is stored as the start address of the TAG (data information) in a predetermined area of the internal memory 13 (Step S33), and the processing proceeds to Step S34.

In Step S34, it is judged whether or not the read data coincides with the TAG (permitted apparatus list) (Step S34). When it is judged that the read data does not coincide with the TAG (permitted apparatus list) (Step S34: NO), the processing proceeds to Step S36. When it is judged that the read data coincides with the TAG (permitted apparatus list) (Step S34: YES), the start address on the disc in which the read data is stored is stored as the start address of the TAG (permitted apparatus list) in a predetermined area of the internal memory 13 (Step S35), and the processing proceeds to Step S36.

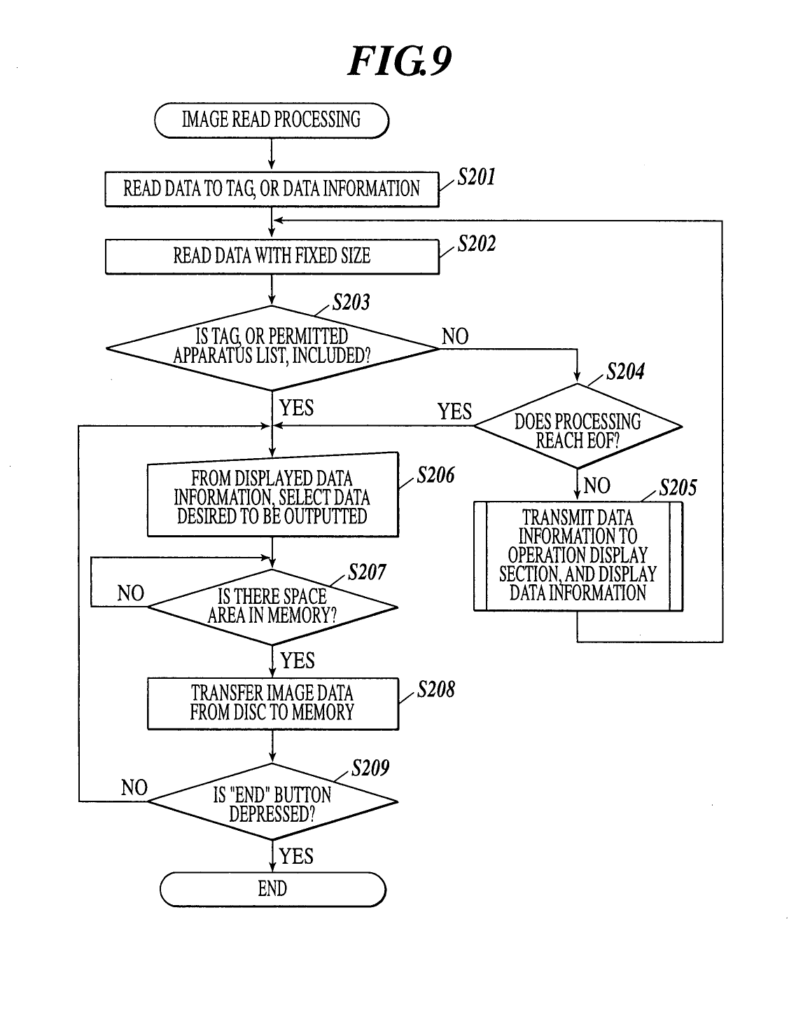

In Step S36, it is judged whether or not the processing reaches the end of the file (EOF). When it is judged that the processing does not reach the EOF (Step S36: NO), the processing returns to Step S31, from which the processing of Steps S31 to S35 is repeatedly executed. When it is judged that the processing reaches the EOF (Step S36: YES), it is judged whether or not the data of the permitted apparatus list is present based on whether or not the start address of the TAG (permitted apparatus list) is stored in the predetermined area of the internal memory 13. When it is judged that the data of the permitted apparatus list is not present (Step S37: NO), image read processing shown in FIG. 9 is executed (Step S40), and this processing is ended. When it is judged that the data of the permitted apparatus list is present (Step S37: YES), the MAC address stored behind the start address of the TAG (permitted apparatus list) on the mounted disc and a MAC address of the apparatus concerned are collated with each other (Step S38). When the MAC address of the apparatus concerned coincides with the MAC address of the permitted apparatus list (Step S39: YES), the image read processing shown in FIG. 9 is executed (Step S40), and this processing is ended. When the MAC address of the apparatus concerned does not coincide with the MAC address of the permitted apparatus list (Step S39: NO), the disc read mode is released (Step S41), and this processing is ended.

FIG. 9 is a flowchart showing the image read processing executed by the CPU 11. This processing is processing realized by software processing executed by cooperation between the CPU 11 and image read processing program stored in the storage section 12.

In the image read processing, first, data to the TAG (data information) on the disc (that is, data stored within 8 bytes from the start address of the TAG (data information)) is read into the internal memory 13 (Step S201). Subsequently, data with a fixed size (size corresponding to the size of the data information; here, 24 bytes) is read into the internal memory 13 (Step S202), and it is judged whether or not the TAG (permitted apparatus list) is included in the read data. When it is judged that the TAG (permitted apparatus list) is not included in the read data (Step S203: NO), it is judged whether or not the processing reaches the EOF. When it is judged that the processing does not reach the EOF (Step S204: NO), the read data, that is, the data information is transmitted to the operation display section 14, and is displayed thereon (Step S205), and the processing returns to Step S202.

When it is judged that the TAG (permitted apparatus list) is included in the read data (Step S203: YES), or when it is judged that the processing reaches the EOF (Step S204: YES), a message to urge the user to select, from the displayed data information, data desired to be outputted is displayed on the operation display section 14. When the data information is selected and inputted (Step S206), it is judged whether or not there is a continuous space area, in the internal memory 13, with a size equal to or more than the data size stored in the selected data information. When it is judged that there is no space area (Step S207: NO), it is awaited that the memory is cleared by another processing to form the space area in the internal memory 13. When it is judged that there is a space area in the internal memory 13 (Step S207: YES), the image data is read from the disc based on the start address and data size of the selected data information, and the read image data is transferred to the internal memory 13 (Step S208). After this transfer is completed, a message such as “do you want to end this?”, an “END” button, and a “CONTINUE” button are pop-up displayed on a screen of the operation display section 14, on which the list of the data information is displayed. When the “CONTINUE” button is depressed (Step S209: NO), the processing returns to Step S206. When the “END” button is depressed (Step S209: YES), this processing is ended.

As described above, in accordance with the image forming apparatus 1, in the write list registration processing, the image data transferred from the scanner section 15 is sequentially stored into the space area of the internal memory 13. Then, every time the storing of the image data in one continuous space area is completed, the memory area information including the start address of the area concerned is sequentially registered in the write list. In the write control processing, the memory area information registered in the write list is sequentially referred to, the area in which the image data is stored is specified, and the image data in the specified area is written into the optical recording medium mounted on the CD/DVD drive 161 from the head of the optical recording medium concerned. Then, after the entire image data to be written is written into the disc, medium area information which is the memory area information in which the start address of the data on the internal memory 13 is changed to a start address of the data on the optical recording medium.

Hence, it becomes possible to write the image data sequentially transferred from the scanner section 15 sequentially into the optical recording medium. Consequently, it becomes unnecessary to, as heretofore, generate the image file after awaiting that the entire image data to be written into the optical recording medium is captured into the internal memory and that the image data to be written is fixed, and write the generated image file into the optical recording medium. In such a way, it becomes possible to shorten the processing time, and in addition, it also becomes unnecessary to ensure a storage capacity for generating the image file.

Moreover, the apparatus identification information about the apparatus permitted to read the written image data can be written into the optical recording medium. Consequently, it becomes possible to perform the restriction on reading so as to make it possible for only the permitted apparatus to read the image data in apparatuses to read data in the optical recording medium.

Furthermore, the data information to be written in the optical recording medium includes the image name as the image identification information about the image data written in each area. Consequently, even if the image data composing one image is distributed and written into the optical recording medium, it becomes possible to identify into which area on the optical recording medium the image data composing the one image is written.

Furthermore, a data structure of a file to be written in the optical recording medium includes, in head of the structure, the data storage section to store the image data sequentially written in the optical recording medium, and includes, in hinder part of the data storage section, the data information section to store the data information including the start address on the optical recording medium relating to the image data for unit of writing into the data storage section. Consequently, it becomes possible to write sequentially the image data in the optical recording medium.

Note that the description contents in the above-described embodiment represent a preferred example of the image forming apparatus 1 according to the present invention, and the present invention is not limited to this embodiment.

For example, in the embodiment, as an example, the case is explained that the input section to which the image data is inputted is the scanner section 15 and the image data sequentially read and inputted by the scanner section 15 is written sequentially into the optical recording medium such as the CD and the DVD; however, the present invention can also be applied to the case where image data from the host computer 2, which is sequentially inputted from the communication section 17, is written into the optical recording medium such as the CD and the DVD.

Besides the above, it is also possible to appropriately alter detailed configurations and operations of the image forming apparatus 1 within the scope without departing from the spirit of the present invention.

What is claimed is:

1. An image data recording apparatus, comprising:
an input section on which image data is inputted;
an internal memory;
a write section to write data into an optical recording medium which is removably mounted onto the write section;
a memory storage control section to sequentially store the image data inputted from the input section into a space area of the internal memory, and every time the storing of the image data is completed, to sequentially register, in a write list, memory area information about an area to which the image data has been stored, the memory area information including a start address of the area; and
a write control section to specify the area in which the inputted image data is stored based on the registered memory area information, to allow the write section to write the data of the specified area into the optical recording medium from a head of the optical recording medium, and to write, into the optical recording medium, medium area information which is the memory area information in which the start address of the data on the internal memory is changed to a start address of the data on the optical recording medium.

2. The image data recording apparatus of claim 1,
wherein, after the write section writes an entirety of the image data which is inputted by the input section and is specified to be written and corresponding medium area information into the optical recording medium, the write control section writes, into the optical recording medium, apparatus identification information about an apparatus permitted to read the image data written in the optical recording medium.

3. The image data recording apparatus of claim 1,
wherein the memory area information includes image identification information about the image data stored in the area, and
when the image data composing one image is stored over a plurality of the areas, the memory storage control section registers identical image identification information to a plurality of pieces of the memory area information about the respective areas in which the image data composing the one image is distributed and stored.

4. The image data recording apparatus of claim 1,
wherein the input section is a scanner to read an image of a document so that image data is inputted thereon.

5. A computer readable medium embodying a program for causing a computer to function as:
a memory control section to sequentially store image data inputted from an input section that receives image data into a space area of an internal memory, and every time the storing of the image data is completed, to sequentially register, in a write list, memory area information about an area to which the image data has been stored, the memory area information including a start address of the area; and
a write control section to specify the area in which the inputted image data is stored based on the registered area information, to allow a write section that writes the data into the optical recording medium to write the data of the specified area into the optical recording medium from a head of the optical recording medium, and to write, into the optical recording medium, medium area information which is the memory area information in which the start address of the data on the internal memory is changed to a start address of the data on the optical recording medium.

6. The medium embodying the program of claim 5,
wherein, after the write section writes an entirety of the image data which is input by the input section and is specified to be written and corresponding medium area information into the optical recording medium, the write control section writes, into the optical recording medium, apparatus identification information about an apparatus permitted to read the image data written in the optical recording medium.

7. The medium embodying the program of claim 5,
wherein the memory area information includes image identification information about the image data stored in the area, and
when the image data composing one image is stored over a plurality of the areas, the memory storage control section registers identical image identification information to a plurality of pieces of the memory area information about the respective areas in which the image data composing the one image is distributed and stored.

8. The medium embodying the program of claim 5,
wherein the input section is a scanner to read an image of a document so that image data is inputted thereon.

9. A data structure of a file storing image data to be written into an optical recording medium through an image data recording apparatus, comprising:
on a head of the data structure, a data storage section to store the image data sequentially written into the optical recording medium; and
next to the data storage section, a data information section to store data information including a start address on the optical recording medium, the data information relating to image data per section by which the image data recording apparatus write the image data into the data storage section of the optical recording medium.

10. The data structure of claim 9, further comprising:
next to the data information section, a permitted apparatus information section to store apparatus identification information about an apparatus permitted to read the image data written in the optical recording medium.
